(19) United States
(12) Patent Application Publication
(10) Pub. No.: US 2006/0237485 A1
(43) Pub. Date: Oct. 26, 2006

(54) All position spray bottle

(76) Inventor: Iksoon An, Leonia, NJ (US)

Correspondence Address: Iksoon An, 327 Beechwood Place, Leonia, NJ, 07605, US

(21) Appl. No.: 11/408,700

(22) Filed: Apr. 20, 2006

Related U.S. Application Data
(60) Provisional application No. 60/673,741, filed on Apr. 22, 2005.

(51) Int. Cl. B67D 5/40

(52) U.S. Cl. 222/376; 222/382; 222/464.1

(57) ABSTRACT

A spray bottle for spraying fluid from all positions, including those where the spray bottle is turned upside down or to a sharp angle.

The present application claims the benefit of U.S. Provisional Application Ser. No. 60/673,741 filed Apr. 22, 2005, entitled “All Position Spray Bottle,” which is incorporated by reference herein in its entirety.

### FIELD OF THE INVENTION

The present invention relates generally to the field of household items, and pertains, more specifically, to a spray bottle that can spray fluid from all positions, including those where the spray bottle is turned upside down or to an angle.

### BACKGROUND OF THE INVENTION

Spray bottles are well-known, useful household items, which can be used in a wide variety of applications such as applying water, cleaning fluids, herbicides, pesticides, fertilizers, and other liquids to desired areas. Numerous embodiments of spray bottles are well-known in the art. Typically, spray bottles include a head and a bottle. The head includes a trigger member that activates a small pump inside the head. The pump is attached to a tube that draws fluid from the bottom of the bottle. In operation, the pump forces fluid drawn by the tube through a barrel and out a small hole or nozzle.

FIG. 1 shows a conventional spray bottle 10. As is well-known in the art, when trigger member 20 is pulled in direction 25, fluid 50 is expelled out nozzle 65. When trigger member 20 is released, additional fluid 50 is drawn in by open end 150 of tube 40.

Turning now to FIGS. 2 and 3, when spray bottle 10 is turned upside down or to an angle, open end 150 of tube 40 is no longer in contact with fluid 50. Without such contact, tube 40 cannot draw any more fluid 50. Consequently, at this point, even if a user repeatedly pulls and releases trigger member 20, no more fluid 50 will be drawn by tube 40 and become available for expulsion.

Despite its utility, conventional spray bottles have a notable shortcoming. They do not work well, or for very long, when they are turned upside down (or to a sharp angle) because the open end of the tube that normally draws in fluid is no longer in contact with the fluid. Accordingly, there exists a need for a spray bottle that can spray fluid from all positions, i.e., even when the spray bottle is turned upside down or to a sharp angle.

### SUMMARY OF THE INVENTION

The present invention is a spray bottle that can spray fluid from all positions, including those where the spray bottle is turned upside down or to a sharp angle. This is a great benefit to users when performing activities such as cleaning toilets, where the spray bottle must often be turned upside down or to an angle.

The spray bottle comprises a head including a trigger member and a nozzle, a bottle, a first tube, a reservoir, and a second tube, where the first tube is connected at a first end to a first end of the reservoir and at a second end to the head, the second tube is connected to a second end of the reservoir, and where the head is connected to the bottle such that the first tube, the reservoir, and the second tube are substantially within the bottle.

In one embodiment, the first tube and the reservoir are one unitary piece. Alternatively, the first tube and the reservoir may be separate pieces connected for fluid communication with each other, in which case the first tube may extend into the first end of the reservoir.

Preferably, the first end of the second tube extends substantially into the reservoir, and may extend far enough into the reservoir such that the first end of the second tube is in proximity to the first end of the reservoir.

The particular size and shape of the reservoir is not important. For example, the reservoir could be of various sizes and be cylindrical, spherical, rectangular, or any other three-dimensional shape. Similarly, the spray bottle can be of any size and shape.

### BRIEF DESCRIPTION OF THE DRAWINGS

The invention will be more fully understood, while still further features and advantages will become apparent, in the following detailed description of preferred embodiments thereof illustrated in the accompanying drawings, in which:

FIG. 1 is a side elevational view of a prior art spray bottle;

FIG. 2 is a side elevational view of the prior art spray bottle of FIG. 1 turned upside down;

FIG. 3 is a side elevational view of the prior art spray bottle of FIG. 1 turned to an angle;

FIG. 4 is a side elevational view of a spray bottle constructed in accordance with one embodiment of the present invention;

FIG. 5 is a side elevational view of the spray bottle of FIG. 4 turned upside down; and

FIG. 6 is a side elevational view of the spray bottle of FIG. 4 turned to an angle.

### DETAILED DESCRIPTION OF THE DRAWINGS

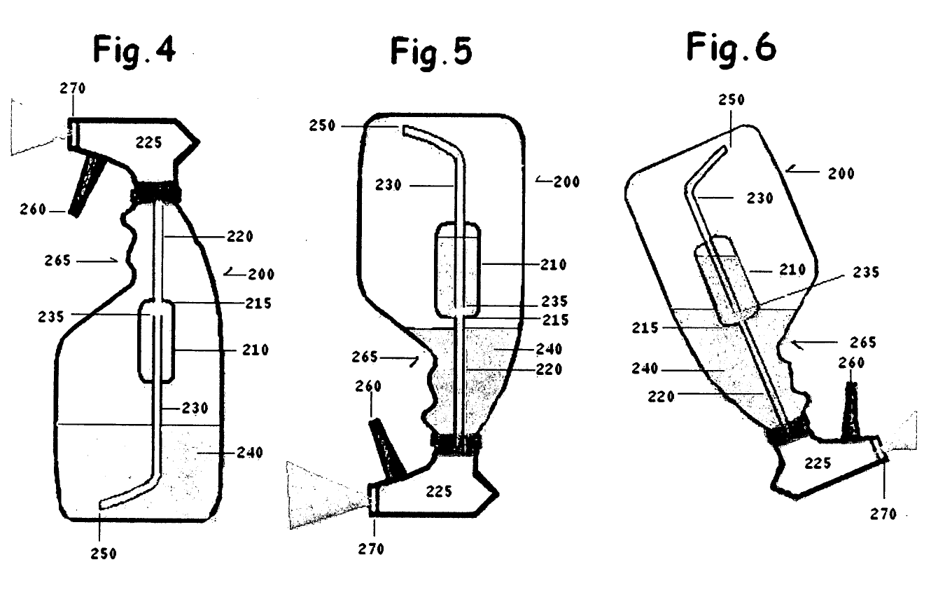

FIGS. 4-6 illustrate an exemplary spray bottle 200 in accordance with the present invention. Spray bottle 200 includes a head 225 with a trigger member 260 that activates a small pump (not shown) inside the head. Spray bottle 200 further includes reservoir 210. Reservoir 210 is connected at one end to first tube 220 and at the other end to second tube 230. First tube 220 and reservoir 210 may be one unitary piece (as shown in FIGS. 4-6), or separate pieces connected for fluid communication with each other. If first tube 220 and reservoir 210 are separate pieces, first tube 220 preferably extends only slightly into reservoir 210, if at all.

Second tube 230, however, is preferably separate from first tube 220 and reservoir 210, as shown in FIGS. 4-6, and preferably extends substantially into reservoir 210, e.g., into almost the top 215 of reservoir 210. Although second tube 230 need not extend substantially into reservoir 210, doing so helps keep reservoir 210 almost entirely full of fluid 240, as the fluid in reservoir 210 will eventually level out at the height or top 235 of second tube 230 when spray bottle 200 is turned to an upright position.

In operation, when trigger member 260 of spray bottle 200 is pulled in direction 265 and released, open end 250 of second tube 230 draws in fluid 240 from the bottom of spray bottle 200 into reservoir 210. Once fluid 240 has made its way up reservoir 210, up through first tube 220, and into an internal chamber (hidden in FIGS. 4-6) inside head 225, spray bottle 200 is ready for use. At this point, when trigger member 260 is pulled in direction 265, fluid 240 will be expelled out nozzle 270.

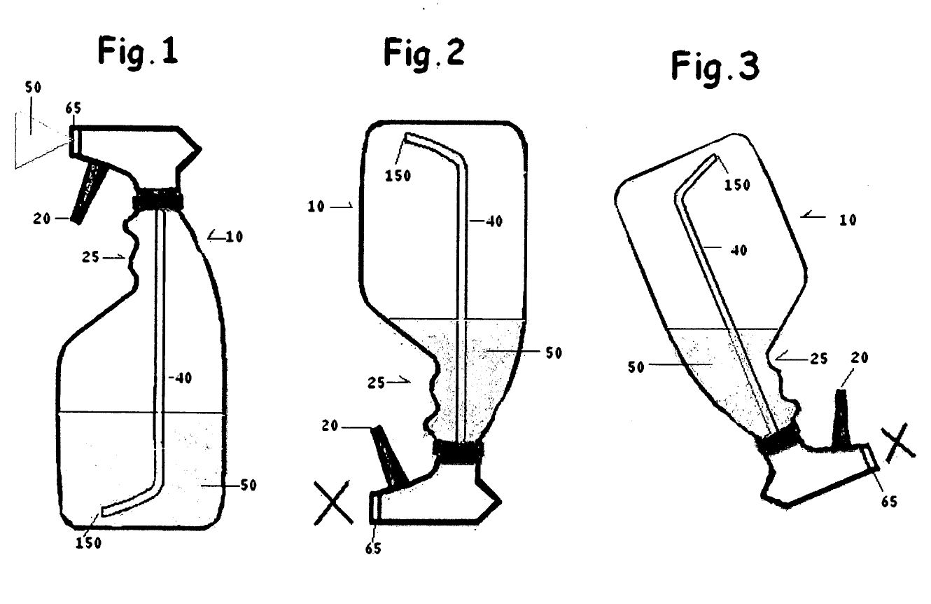

As shown in FIGS. 5 and 6, respectively, even when spray bottle 200 is turned upside down or to an angle, fluid may still be expelled. This is because even though no further fluid 240 may be drawn by second tube 230 into reservoir 210 because open end 250 is not in contact with fluid 240, the fluid already in reservoir 210 is still available for expulsion. Thus, unlike conventional spray bottle 10 (FIGS. 1-3), spray bottle 200 may be used even when open 250 of second tube 230 is not in contact with fluid 240, which, as previously explained, may occur when spray bottle 200 is turned upside down as illustrated in FIG. 5, or to an angle as illustrated in FIG. 6. This is a great benefit to users wishing to use a spray bottle upside down or at an angle. Once the fluid in reservoir 210 has been exhausted, the user need only turn spray bottle 200 right side up (or to an angle where open end 250 of second tube 230 again comes into contact with fluid 240) and pull and release trigger member 260 to refill reservoir 210.

As described above, reservoir 210 provides fluid for expulsion in instances where open end 250 of second tube 230 is not in contact with fluid 240. The particular size and shape of reservoir 210 is not important. For example, reservoir 210 could be of various sizes and be cylindrical, spherical, rectangular, or any other three-dimensional shape. Similarly, spray bottle 200 can be of any size and shape.

It is should be understood that the foregoing general description is merely exemplary and explanatory and is not meant to restrict the invention. It will be apparent to those skilled in the art that various modifications and variations may be made to the description without departing from the scope and spirit of the present invention. It is intended that the present invention cover such modifications and variations.

What is claimed is:

1. A spray bottle comprising:
a head including a trigger member and a nozzle;
a bottle;
a first tube;
a reservoir; and
a second tube;
wherein
said first tube is connected at a first end to a first end of the reservoir and at a second end to the head;
said second tube is connected to a second end of the reservoir; and
said head is connected to the bottle such that the first tube, the reservoir, and the second tube are substantially within the bottle.

2. The spray bottle according to claim 1, wherein said first tube and said reservoir are one unitary piece.

3. The spray bottle according to claim 1, wherein said first tube and said reservoir are separate pieces connected for fluid communication with each other.

4. The spray bottle according to claim 3, wherein said first end of said first tube extends into said first end of said reservoir.

5. The spray bottle according to claims 1 wherein a first end of said second tube extends substantially into the reservoir.

6. The spray bottle according to claim 5, wherein said first end of said second tube is in proximity to the first end of the reservoir.

7. The spray bottle according to claim 1, wherein said reservoir is substantially cylindrical in shape.

8. The spray bottle according to claim 1, wherein said reservoir is substantially spherical in shape.

9. The spray bottle according to claim 1, wherein said reservoir is substantially rectangular in shape.
